(19) United States
(12) Patent Application Publication
(10) Pub. No.: US 2025/0187232 A1
(43) Pub. Date: Jun. 12, 2025

(54) METHOD FOR REMOVING COLOR FROM POLYMERIC MATERIALS FOR CHEMICAL RECYCLING

(71) Applicant: International Business Machines Corporation, Armonk, NY (US)

(72) Inventors: Lucas Charles Moore, San Jose, CA (US); Gregory Breyta, San Jose, CA (US)

(21) Appl. No.: 18/535,848

(22) Filed: Dec. 11, 2023

(51) Int. Cl. B29B 17/02; B29K 67/00; B29K 105/00; C08J 11/08

(52) U.S. Cl. CPC B29B 17/02; C08J 11/08; B29B 2017/0293; B29K 2067/003; B29K 2105/0032; B29K 2995/002; C08J 2367/02

(57) ABSTRACT

An acetonitrile, toluene, and/or xylene solvent removes color from a polymeric material in a device with a boiling vessel, a condenser, and a chamber. The solvent is placed in the boiling vessel and the polymeric material is placed in the chamber. Upon heating, solvent vapors travel from the boiling vessel to the condenser where the vaporized solvent is condensed back to a liquid that enters into the chamber where it extracts color from the polymeric material and forms a mixture, which is directed back to the boiling vessel. The decolorization is repeated via a continuous loop or a continuous-feed to remove all color from the polymeric material so that the polymeric material can be chemically recycled. The extracted colorant and solvent in the mixture may reused by filtering the mixture or by evaporating the solvent from the mixture and recondensing the solvent back to a liquid state.

### TECHNICAL FIELD

The present invention relates generally to recycling, and more specifically to a method for removing color from polymeric materials so that the polymeric materials may be chemically recycled.

### BACKGROUND OF THE INVENTION

When recycling polymeric materials, the polymeric material should be free from color prior to the recycling of the material. Most recyclable feedstocks contain colorants (dyes, pigments, inks) that must be removed in order to produce a colorless product. Methods exist for the removal of colorants from polymeric material, but as such methods have substantial drawbacks, the vast majority of recycled polymers are colorless. Highly colored polymers often are not recyclable using current technology and often must be disposed of in a landfill or by incineration. Current methods of dye removal from polymeric materials for the purposes of recycling include pre-processing decolorization and post-processing decolorization.

With pre-processing decolorization, the colored material is soaked in an aqueous or organic solvent that extracts the dye or alternatively, the colored material is subjected to high-shear mixing. With the solvent soaking method, the solubility limits of the colorant material in the solvent and/or the relative partitioning of the colorant in the solvent versus the polymer limit the efficiency of the colorant extraction. Because of these limits, there is always a substantial amount of colorant remaining in the polymer. To partially circumvent this problem, large amounts of solvent are required, which render the process economically or environmentally unsuitable for commercial use. With the high-shear mixing, specific equipment and solvents are required that complicate the colorant extraction. For example, the solvent used in high-shear mixing decolorization is an ionic liquid, which requires mixing with water to remove the dye, and the water must be evaporated from the solution in order to reuse the solvent. Water requires a large quantity of energy to evaporate, a step that limits the economic viability of the process.

With post-processing decolorization, the polymer is depolymerized to oligomeric or monomeric materials, then the color is removed from a solution of the depolymerized material in a solvent, often with activated carbon or other adsorption materials for a continuous colorant extraction process. With solvent color removal, the oligomer/monomer solution is exposed to an adsorbent, usually activated carbon, to remove the dissolved colorants. While solvent color removal is capable of removing trace amounts of colorants, the process is overwhelmed by the large quantities of colorants found in dark-colored fabrics. To partially circumvent this problem, large amounts of adsorbent can be used, but this renders the process economically unsuitable for commercial use.

In view of the foregoing, there remains a need in the art for a more efficient method of color removal from polymeric materials.

### SUMMARY OF THE INVENTION

The present invention overcomes the need in the art with an extraction process that removes the color from polymeric materials with an organic solvent at elevated temperatures. Upon completion of the extraction, the decolored polymeric material is ready for chemical recycling, the removed colorant may be collected and used to dye new materials, and the organic solvent may be recovered and reused for additional extractions.

In one embodiment, the present invention relates to a method for removal of colorants from a polymeric material comprising: (a) placing a solvent in a boiling vessel that is coupled to a condenser; (b) placing the polymeric material in a chamber that is coupled to the condenser and the boiling vessel; (c) heating the boiling vessel to vaporize the solvent, wherein (i) the vaporized solvent travels into the condenser and forms a condensate, (ii) the condensate is directed into the chamber where it extracts colorant from the polymeric material and forms a mixture with the extracted colorant, and (iii) the mixture is directed into the boiling vessel; and (d) repeating (c) in a continuous loop until the polymeric material in the chamber is free of colorant.

In another embodiment, the present invention relates to a method for the removal of colorants from a polymeric material comprising: (a) placing a solvent in a boiling vessel, wherein the boiling vessel is coupled to a condenser via a side arm; (b) placing the polymeric material in a chamber with a first open end and a second open end, wherein the first open end of the chamber is coupled to the condenser and the second open end of the chamber is coupled to the boiling vessel; (c) heating the boiling vessel to vaporize the solvent, wherein the vaporized solvent travels into the condenser via the side arm and forms a condensate, wherein the condensate (i) enters into the chamber through the first open end of the chamber, (ii) extracts colorant from the polymeric material, and (iii) forms a mixture with the extracted colorant, wherein the mixture is directed into the boiling vessel through the second open end of the chamber; (d) repeating (c) in a continuous loop until the polymeric material in the chamber is free of colorant; and (e) collecting the mixture from the boiling vessel and separating the extracted colorant and the condensate for reuse.

In a further embodiment, the solvent is selected from the group consisting of acetonitrile, toluene, xylene, and combinations thereof.

In another embodiment, the polymeric material comprises a polyester selected from the group consisting of polyethylene terephthalate (PET), polyethylene naphthalate (PEN), polybutylene terephthalate (PBT), polytrimethylene terephthalate (PTI), polyethylene furanoate (PEF), and combinations thereof.

In a further embodiment, the present invention relates to a method for removal of colorants from a polymeric material comprising: (a) placing acetonitrile in a boiling vessel that is coupled to a condenser; (b) placing a polymeric material comprising polyethylene terephthalate (PET) in a chamber that is coupled to the condenser and the boiling vessel; (c) heating the boiling vessel to vaporize the acetonitrile, wherein the vaporized acetonitrile travels into the condenser and forms a condensate, wherein the condensate (i) is directed into the chamber, (ii) extracts colorant from the polymeric material, and (iii) forms a mixture with the extracted colorant, wherein the mixture is directed into the boiling vessel; and (d) repeating (c) in a continuous loop until the polymeric material in the chamber is free of colorant.

In another embodiment, the present invention relates to a method for removal of colorants from a polymeric material comprising: (a) placing toluene in a boiling vessel that is coupled to a condenser; (b) placing a polymeric material comprising polyethylene terephthalate (PET) in a chamber that is coupled to the condenser and the boiling vessel; (c) heating the boiling vessel to vaporize the toluene, wherein the vaporized toluene travels into the condenser and forms a condensate, wherein the condensate (i) is directed into the chamber, (ii) extracts colorant from the polymeric material, and (iii) forms a mixture with the extracted colorant, wherein the mixture is directed into the boiling vessel; and (d) repeating (c) in a continuous loop until the polymeric material in the chamber is free of colorant.

In a further embodiment, the present invention relates to a method for the removal of colorants from a polymeric material comprising: (a) placing xylene in a boiling vessel, wherein the boiling vessel is coupled to a condenser via a side arm; (b) placing a polymeric material comprising polyethylene terephthalate (PET) in a chamber with a first open end and a second open end, wherein the first open end of the chamber is coupled to the condenser and the second open end of the chamber is coupled to the boiling vessel; (c) heating the boiling vessel to vaporize the xylene, wherein the vaporized xylene travels into the condenser via the side arm and forms a condensate, wherein the condensate (i) enters into the chamber through the first open end of the chamber, (ii) extracts colorant from the polymeric material, and (iii) forms a mixture with the extracted colorant, wherein the mixture is directed into the boiling vessel through the second open end of the chamber; (d) repeating (c) in a continuous loop until the polymeric material in the chamber is free of colorant; and (e) collecting the mixture from the boiling vessel and separating the extracted colorant and the condensate for reuse.

In another embodiment, the condensate is directed to the second chamber via gravity.

In a further embodiment, the condensate is directed to the second chamber with a pump.

In another embodiment, the polymeric material that is free of color is removed from the second chamber, dried, and chemically recycled for reuse.

In a further embodiment, the extracted colorant and the condensate in the mixture are separated for reuse via filtration.

In another embodiment, the extracted colorant and the condensate in the mixture are separated for reuse via evaporation.

Additional aspects and/or embodiments of the invention will be provided, without limitation, in the detailed description of the invention that is set forth below.

### BRIEF DESCRIPTION OF THE DRAWINGS

FIG. 1 is a flow chart showing the process flow for the method of removing color from a polymeric material as described herein.

FIG. 2A is a diagram of a solvent extraction device for the removal of color from polymeric materials that may be used in a continuous loop and FIG. 2B is a photograph showing the device in a laboratory setting.

FIG. 3 is a diagram of a continuous-feed solvent extraction device for the removal of color from polymeric materials.

FIGS. 4A and 4B are photographs showing products obtained from the polymeric material decolorization method described herein.

### DETAILED DESCRIPTION OF THE INVENTION

Set forth below is a description of what are currently believed to be preferred aspects and/or embodiments of the claimed invention. Any alternates or modifications in function, purpose, or structure are intended to be covered by the appended claims. As used in this specification and the appended claims, the singular forms “a,” “an,” and “the” include plural referents unless the context clearly dictates otherwise. The terms “comprise,” “comprised,” “comprises,” and/or “comprising,” as used in the specification and appended claims, specify the presence of the expressly recited components, elements, features, and/or steps, but do not preclude the presence or addition of one or more other components, elements, features, and/or steps.

Described herein is a method to remove color from polymeric materials prior to introduction of the polymeric materials into a chemical recycling process. Color is removed from polymeric materials by exposing the material to a condensed hot solvent that passes through the material and extracts colorant compounds that are dissolved in the fibers of the material. The solvent that has passed through the material may be subsequently recollected, reevaporated, recondensed, and passed back through the material to extract additional color. The evaporation-condensation-extraction loop results in a polymeric material that is decolored and a colored solvent with a high concentration of colorant. When the extraction process is complete, the decolored polymeric material may be recycled in chemical recycling process. The colored solvent obtained at the completion of the color extraction may be separated from the colorant by evaporation and/or filtration. Upon separation, the solvent may be reused for additional color extractions and the colorant may be reused for the dying of new materials. The method may be used with any synthetic fabric that has been colored with any type of pigment, dye, and/or ink.

One non-limiting example of a chemical recycling process that may use the decolorized polymeric material of the claimed method is the volatile catalyst (VolCat) method described in U.S. Pat. No. 9,255,194 B2 to Allen et al. and U.S. Pat. No. 9,914,816 B2 to Allen et al. The VolCat process depolymerizes polyester with an alcohol solvent and an amine organocatalyst and/or carboxylic acid salt of same in a reactor at a temperature at or higher than the boiling point of the alcohol solvent. Reaction products from the VolCat depolymerization are monomeric and/or oligomeric diesters from the polyester as well as recovered organocatalyst and excess alcohol solvent, the former of which is intended for reuse into recycled polyester products and the latter of which may also be reused in subsequent depolymerization reactions.

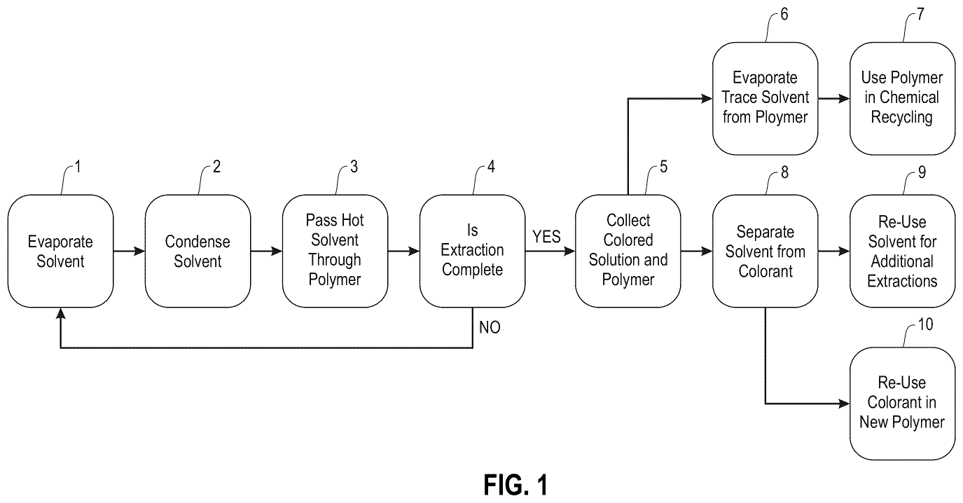

FIG. 1 describes the solvent extraction steps that are used to decolor polymeric materials. The steps include evaporation of the extraction solvent 1, condensing of the solvent into a liquid 2, passing the hot condensed solvent through the polymer 3, and determining if the extraction is complete 4. If the extraction is not complete, then the extraction process at steps 1-3 is repeated in a continuous loop or in batches until the polymeric material is free of color. Once the polymeric material has been decolorized, it is collected from the color extraction device 5 and any solvent remaining in the polymeric materials is allowed to evaporate 6. Once the polymeric material is free of solvent, it is available for chemical recycling 7. The colored solution remaining after the extraction is also collected 5 and is filtered to separate the solvent from the colorant 8. Once the solvent and colorant are separated, the solvent may be used for additional extractions 9 and the colorant may be reused to color other polymeric materials 10.

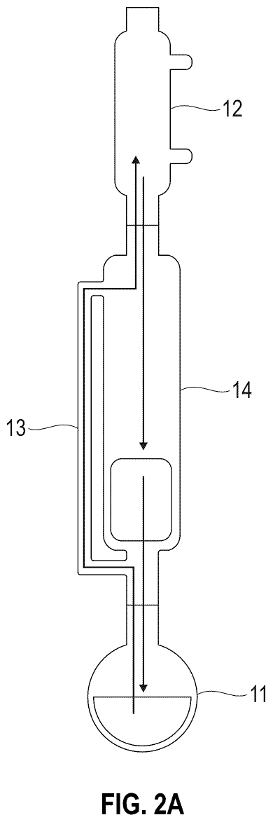

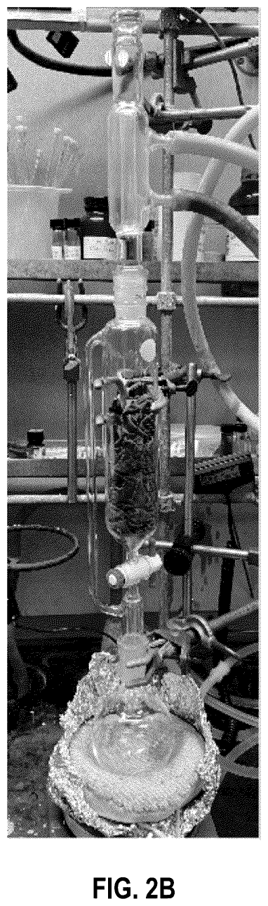

FIG. 2A is a diagram of a representative solvent extraction device for the removal of color from a polymeric material. The device includes a solvent boiling vessel 11, a condenser 12, a side arm 13 linking the solvent boiling vessel to the condenser, and an addition funnel 14 (also referred to herein as a “chamber”). FIG. 2B is a photograph showing the set-up in a laboratory setting. The valve shown in the photograph is present only as part of the set-up, but is not a necessary part of the set-up. During the operation of the set-up shown in FIG. 2B (and described in Example 1), the valve was kept open throughout the solvent extraction process. The polymeric material placed in the chamber did not fall through the lower opening of the chamber because such opening was very small (<5 mm). In other situations and/or set-ups where the polymeric material may fall through the opening, a platform may be placed within the chamber to keep the polymeric material in place.

In operation, the solvent is placed in the solvent boiling vessel 11, the polymeric material is placed in the addition funnel 14, and the solvent is placed in the boiling vessel 11. The solvent in the boiling vessel 11 is heated to the solvent boiling point in order to vaporize the solvent. Once the solvent has vaporized, the solvent vapor travels from the solvent boiling vessel 11 to the condenser 12 via the side arm 13. Within the condenser 12, the vapor condenses into a liquid (referred to herein as a “condensed solvent” or “condensate”) that drips from the condenser 12 into the addition funnel 14 via gravity. During the initial heating of the solvent, the vapor may travel from the boiling vessel 11 into both the addition funnel 14 and the side arm 13; however, once the addition funnel fills with the condensate, the presence of the condensed solvent in the addition funnel blocks any additional vapor from entering the addition funnel and the vapor is directed to the condenser 12 via the side arm 13. Within the addition funnel 14, the condensate contacts and extracts color from the polymeric material. When the condensate returns to the boiling vessel 11 after passing through the polymeric material in the addition funnel 14, the condensate is a colored solvent. The evaporation-condensation-extraction is repeated in a continuous loop until the polymeric material is free of color at which time, it is removed from the addition funnel 14 for recycling in a chemical recycling process. The colored solvent remaining in the solvent boiling vessel 11 is evaporated and/or filtered to separate the solvent from the colorant, where the former may be reused in additional solvent extractions and the latter may be reused to dye new materials.

The devices shown in FIGS. 2A and 2B may be modified to increase efficiency. For example, in one embodiment, the addition funnel may be heated to increase the extraction efficiency. In another embodiment, instead of the addition funnel being a static chamber, as is shown in FIGS. 2A and 2B, the addition funnel may include a conveyance, such as an auger, which moves the colored fabric through the chamber and the decolored fabric out of the chamber. In a further embodiment, the extraction solvent may be gravity fed into the extraction chamber. In another embodiment, the extraction solvent may be pumped into a counter-current flow compared to the flow of the fabric. In all embodiments, feed rates of the extraction solvent and fabric should be balanced so that the residence time of the fabric is sufficient for total colorant extraction.

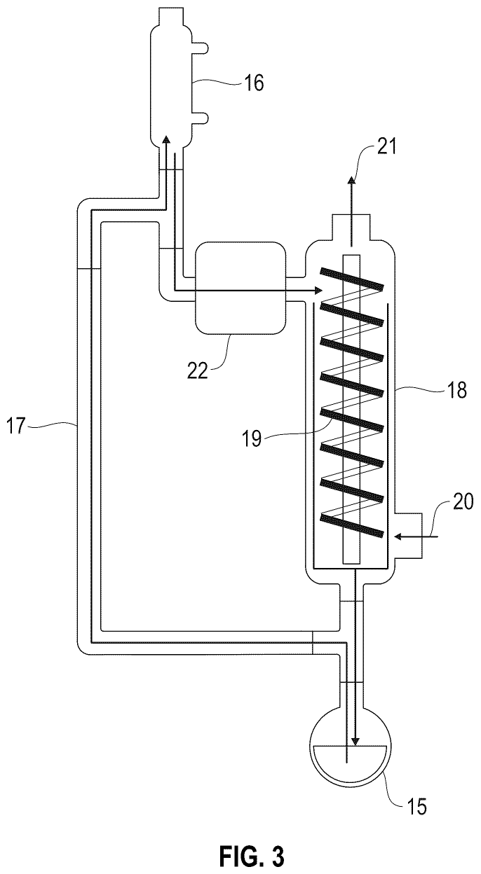

FIG. 3 is a diagram of a representative continuous-feed solvent extraction device for the removal of color from a polymeric material. The device includes a solvent boiling vessel 15; a condenser 16; a side arm 17 linking the solvent boiling vessel to the condenser; an addition funnel (also referred to herein as a “chamber”) 18 with an auger 19 with countercurrent flow, a polymer inlet 20, and a polymer outlet 21, and a solvent pump 22. In operation, the solvent is placed in the solvent boiling vessel 15, the polymer outlet 21 is closed, the polymeric material is input into the addition funnel 19 via the polymer inlet 21, the solvent pump 22 is turned on, and the solvent in the boiling vessel 15 is heated to the solvent boiling point. The turning on of the solvent pump 22 initiates the spiraling of the auger 19 within the addition funnel 18. Due to the higher pressure within the addition funnel 18 caused by the solvent pump 22, once the solvent is boiled, the solvent vapor cannot enter into the addition funnel 18 and travels from the solvent boiling vessel 15 to the condenser 16 via the side arm 17.

Once the solvent is sufficiently condensed into a liquid (referred to herein as a “condensed solvent” or “condensate”), the condensed solvent from the condenser 16 is pumped via the solvent pump 22 into the addition funnel 18 where the countercurrent flow of the auger 19 spirals the polymeric material in one direction and the condensed solvent in another direction thus ensuring a maximal amount of the surface area of the polymeric material to encounter the condensed solvent. As long as the solvent pump 22 remains turned on, the evaporation-condensation-extraction loop continues as an uninterrupted conveyance. When the polymeric material has been sufficiently exposed to the condensed solvent, the solvent pump 22 is turned off so that the colored solvent may be returned to the solvent boiling vessel 15, and the polymer output 21 is opened so that the decolored polymeric material may be removed from the addition funnel 18.

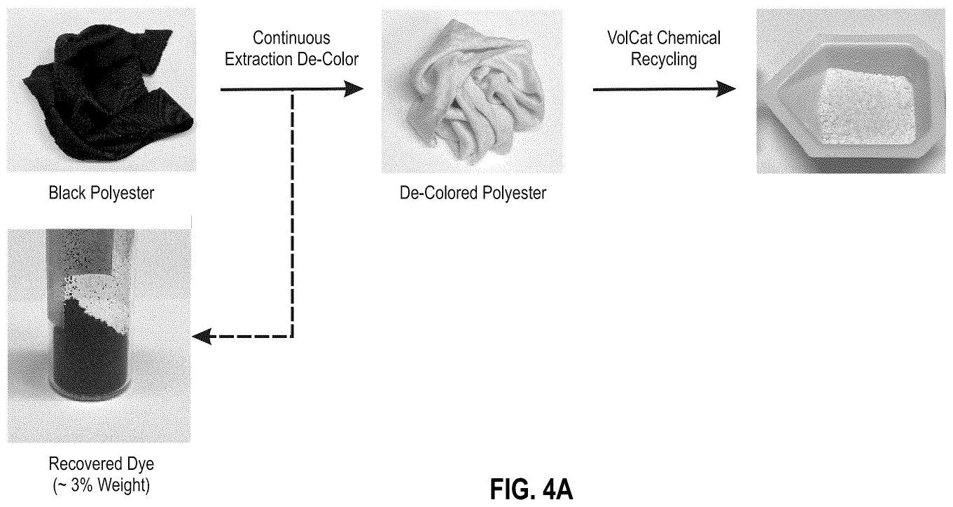

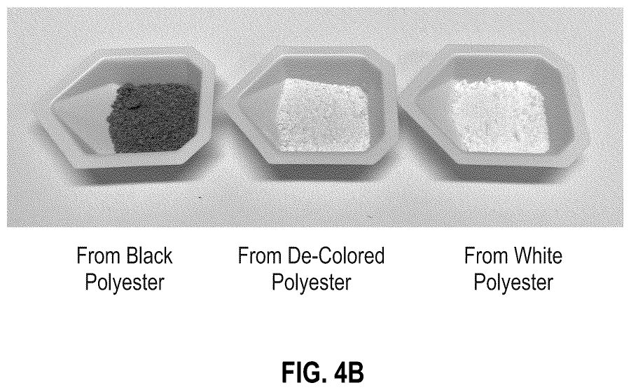

FIG. 4A are photographs showing products recovered from the solvent extraction method as applied to the black polyester fabric described in Example 1. After continuous solvent extraction of the black polyester in the solvent extraction device of FIG. 2B, the black polyester was decolored to a very light color, which was recycled via VolCat chemical recycling. The VolCat product shown in FIG. 2B is an intermediate monomer product that has a color that is suitable for reuse. Also recovered from the solvent extraction was black dye in an amount of ˜3% by weight of the black polyester fabric. FIG. 4B shows three different intermediate monomer products recovered from the VolCat recycling of a black polyester fabric, a decolored black polyester fabric (also shown in FIG. 4A), and a white polyester fabric. The VolCat recycling of the black polyester fabric produced a dark monomer product. Because any color in the intermediate monomer product will be present in the fully recycled polymer product, the dark color of the monomer product produced from the black polyester fabric is not suitable for reuse. By contrast, the VolCat recycling of the decolored polyester fabric produced a monomer product that is close in color to the monomer product produced from the recycled white polyester fabric. Both the decolored and the white monomer products produced from the VolCat chemical recycling are equally suitable for reuse. While the monomer products in FIGS. 4A and 4B were obtained via VolCat chemical recycling, it is to be understood that any chemical recycling process known in the art may be used to recycle the decolored polyester materials produced via the solvent decolorization method described herein.

In one embodiment, color is removed from a polymeric material by (a) placing a solvent in a boiling vessel that is coupled to a condenser; (b) placing the polymeric material in a chamber that is coupled to the condenser and the boiling vessel; (c) heating the boiling vessel to vaporize the solvent, wherein (i) the vaporized solvent travels into the condenser and forms a condensate, (ii) the condensate is directed into the chamber where it extracts colorant from the polymeric material and forms a mixture with the extracted colorant, and (iii) the mixture is directed into the boiling vessel; and (d) repeating (c) in a continuous loop until the polymeric material in the chamber is free of colorant.

In another embodiment, the first chamber is a boiling vessel and the second chamber is an addition funnel. In a further embodiment, the first chamber is coupled to the condenser via a side arm.

In a further embodiment, the solvents that may be used for the solvent extraction are acetonitrile, toluene, or xylene. Only a single solvent is required for the extraction, which simplifies purification and reuse of the solvent. As described herein, the solvent heated to its boiling point, used to extract color from polymeric material, and separated via evaporation and/or filtration from the colorant of the polymeric materials. Once the solvent has been separated from the colorants, the solvent is available for reuse in an additional extraction process. The boiling point of acetonitrile is ˜179.6° C.; the boiling point of toluene is 231.1° C.; and the boiling point of xylene is 139.3° C. for m-xylene, 144.4° C. for o-xylene, 137° C. for p-xylene, and 137° C. for mixed isomer xylene.

In another embodiment, the solvent is selected from the group consisting of acetonitrile, toluene, xylene, combinations thereof.

Examples of polymeric material suitable for the solvent extraction will comprise a polyester selected from the group consisting of polyethylene terephthalate (PET), polyethylene naphthalate (PEN), polybutylene terephthalate (PBT), polytrimethylene terephthalate (PTI), polyethylene furanoate (PEF), and combinations thereof.

In a further embodiment, the condensed solvent is directed to the second chamber via gravity. In a further embodiment, the condensed solvent is directed to the second chamber with a pump.

In another embodiment, after completion of the continuous loop extraction, the decolorized polymeric material is removed from the second chamber, dried, and reused in a chemical recycling process.

In a further embodiment, the mixture of the extracted colorant and the solvent is collected from the boiling vessel and the extracted colorant and the solvent are separated for reuse. In a further embodiment, the extracted colorant and the solvent are separated by filtration. In another embodiment, the extracted colorant and the solvent are separated by evaporating the solvent, wherein the evaporated solvent is recondensed into a liquid for reuse.

The decolorization method described herein circumvents the issues with the decolorization methods known in the art. For example, compared to the pre-processing methods, the solvent used in the method described herein is evaporated and recondensed just prior to contact with the colored polymeric material; a step that ensures that the solvent is nearly boiling and which increases extraction efficiency. The evaporation/recondensation of the solvent also ensures that the polymeric material contacts as much solvent as possible that does not already contain colorant, so more colorant per unit volume of solvent can be removed. Compared to the post-depolymerization methods, the currently described process removes colorants before they can contaminate the oligomer/monomer solutions. Because no colorants are present by the depolymerization step, adsorbent materials are not necessary. In further contrast to the currently used decolorization methods, the decolorization method described herein can be performed with common laboratory glassware or common industrial-scale vessels. Example 1 describes solvent extraction of a black polyester fabric in the set-up shown in FIG. 2B, which includes a 1000 mL round bottom flask and an addition funnel and condenser sized to fit the round bottom flask. The process described in Example 1 may be applied to larger-scale operations with minimal changes, such as increasing the volumes of the vessels and the heat transfer capacities of the boiling vessel and the condenser.

The descriptions of the various aspects and/or embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the aspects and/or embodiments, the practical application or technical improvement over technologies found in the marketplace, or to enable others of ordinary skill in the art to understand the aspects and/or embodiments disclosed herein.

### Experimental

The following example is set forth to provide those of ordinary skill in the art with a complete disclosure of how to make and use the aspects and embodiments of the invention as set forth herein. While efforts have been made to ensure accuracy with respect to variables such as amounts, temperature, etc., experimental error and deviations should be considered. Unless indicated otherwise, parts are parts by weight, temperature is degrees centigrade, and pressure is at or near atmospheric. All components were obtained commercially unless otherwise indicated.

### Example 1

A 1000 mL addition funnel was filled with approximately 75 grams of black polyester fabric. Below the addition funnel, a 1000 mL round-bottom flask was attached and partially filled to approximately 50% with toluene solvent. The top of the addition funnel was equipped with a water-cooled solvent condenser. The round bottom flask was heated to bring the solvent to a boil, which caused the solvent vapor to travel up the side arm of the addition funnel and condense at the condenser. The solvent then fell down to the polyester fabric, passed through it, and dropped back into the solvent boiling flask. The set-up of the solvent extraction as used is shown in FIG. 2B and the products of the decolorization reaction carried out with the set-up are shown in FIG. 4A.

We claim:

1. A method for removal of colorants from a polymeric material comprising:
(a) placing a solvent in a boiling vessel that is coupled to a condenser;
(b) placing the polymeric material in a chamber that is coupled to the condenser and the boiling vessel;
(c) heating the boiling vessel to vaporize the solvent, wherein (i) the vaporized solvent travels into the condenser and forms a condensate, (ii) the condensate is directed into the chamber where it extracts colorant from the polymeric material and forms a mixture with the extracted colorant, and (iii) the mixture is directed into the boiling vessel; and
(d) repeating (c) in a continuous loop until the polymeric material in the chamber is free of colorant.

2. The method of claim 1, wherein the solvent is selected from the group consisting of acetonitrile, toluene, xylene, and combinations thereof.

3. The method of claim 1, wherein the polymeric material comprises a polyester selected from the group consisting of polyethylene terephthalate (PET), polyethylene naphthalate (PEN), polybutylene terephthalate (PBT), polytrimethylene terephthalate (PTI), polyethylene furanoate (PEF), and combinations thereof.

4. The method of claim 1, wherein the condensate is directed to the second chamber via gravity.

5. The method of claim 1, wherein the condensate is directed to the second chamber with a pump.

6. The method of claim 1, wherein the polymeric material that is free of color is removed from the second chamber, dried, and chemically recycled for reuse.

7. The method of claim 1, wherein extracted colorant and the condensate in the mixture are separated for reuse via filtration or evaporation.

8. A method for the removal of colorants from a polymeric material comprising:
(a) placing a solvent in a boiling vessel, wherein the boiling vessel is coupled to a condenser via a side arm;
(b) placing the polymeric material in a chamber with a first open end and a second open end, wherein the first open end of the chamber is coupled to the condenser and the second open end of the chamber is coupled to the boiling vessel;
(c) heating the boiling vessel to vaporize the solvent, wherein the vaporized solvent travels into the condenser via the side arm and forms a condensate, wherein the condensate (i) enters into the chamber through the first open end of the chamber, (ii) extracts colorant from the polymeric material, and (iii) forms a mixture with the extracted colorant, wherein the mixture is directed into the boiling vessel through the second open end of the chamber;
(d) repeating (c) in a continuous loop until the polymeric material in the chamber is free of colorant; and
(e) collecting the mixture from the boiling vessel and separating the extracted colorant and the condensate for reuse.

9. The method of claim 8, wherein the solvent is selected from the group consisting of acetonitrile, toluene, xylene, and combinations thereof.

10. The method of claim 8, wherein the polymeric material comprises a polyester selected from the group consisting of polyethylene terephthalate (PET), polyethylene naphthalate (PEN), polybutylene terephthalate (PBT), polytrimethylene terephthalate (PTI), polyethylene furanoate (PEF), and combinations thereof.

11. The method of claim 8, wherein the condensate is directed to the chamber via gravity or with a pump.

12. The method of claim 8, wherein the polymeric material that is free of color is removed from the chamber, dried and chemically recycled for reuse.

13. The method of claim 8, wherein the extracted colorant and the condensate are separated via filtration or evaporation.

14. A method for removal of colorants from a polymeric material comprising:
(a) placing acetonitrile in a boiling vessel that is coupled to a condenser;
(b) placing a polymeric material comprising polyethylene terephthalate (PET) in a chamber that is coupled to the condenser and the boiling vessel;
(c) heating the boiling vessel to vaporize the acetonitrile, wherein the vaporized acetonitrile travels into the condenser and forms a condensate, wherein the condensate (i) is directed into the chamber, (ii) extracts colorant from the polymeric material, and (iii) forms a mixture with the extracted colorant, wherein the mixture is directed into the boiling vessel; and
(d) repeating (c) in a continuous loop until the polymeric material in the chamber is free of colorant.

15. The method of claim 14, wherein the condensate is directed to the second chamber via gravity or with a pump.

16. The method of claim 14, wherein the polymeric material that is free of color is removed from the second chamber, dried, and chemically recycled for reuse.

17. The method of claim 14, wherein the extracted colorant and the condensate in the mixture are separated for reuse via filtration or evaporation.

18. A method for removal of colorants from a polymeric material comprising:
(a) placing toluene in a boiling vessel that is coupled to a condenser;
(b) placing a polymeric material comprising polyethylene terephthalate (PET) in a chamber that is coupled to the condenser and the boiling vessel;
(c) heating the boiling vessel to vaporize the toluene, wherein the vaporized toluene travels into the condenser and forms a condensate, wherein the condensate (i) is directed into the chamber, (ii) extracts colorant from the polymeric material, and (iii) forms a mixture with the extracted colorant, wherein the mixture is directed into the boiling vessel; and
(d) repeating (c) in a continuous loop until the polymeric material in the chamber is free of colorant.

19. The method of claim 18, wherein the condensate is directed to the second chamber via gravity or with a pump.

20. The method of claim 18, wherein the polymeric material that is free of color is removed from the second chamber, dried, and chemically recycled for reuse.

21. The method of claim 18, wherein the extracted colorant and the condensate in the mixture are separated for reuse via filtration or evaporation.

22. A method for the removal of colorants from a polymeric material comprising:
(a) placing xylene in a boiling vessel, wherein the boiling vessel is coupled to a condenser via a side arm;
(b) placing a polymeric material comprising polyethylene terephthalate (PET) in a chamber with a first open end and a second open end, wherein the first open end of the chamber is coupled to the condenser and the second open end of the chamber is coupled to the boiling vessel;
(c) heating the boiling vessel to vaporize the xylene, wherein the vaporized xylene travels into the condenser via the side arm and forms a condensate, wherein the condensate (i) enters into the chamber through the first open end of the chamber, (ii) extracts colorant from the polymeric material, and (iii) forms a mixture with the extracted colorant, wherein the mixture is directed into the boiling vessel through the second open end of the chamber;
(d) repeating (c) in a continuous loop until the polymeric material in the chamber is free of colorant; and
(e) collecting the mixture from the boiling vessel and separating the extracted colorant and the condensate for reuse.

23. The method of claim 22, wherein the condensate is directed to the second chamber via gravity or with a pump.

24. The method of claim 22, wherein the polymeric material that is free of color is removed from the second chamber, dried, and chemically recycled for reuse.

25. The method of claim 22, wherein the extracted colorant and the condensate are separated via filtration or evaporation.
